(19) United States
(12) Patent Application Publication
(10) Pub. No.: US 2014/0057489 A1
(43) Pub. Date: Feb. 27, 2014

(54) DUAL COUPLER STAY

(71) Applicant: Camas Elaine Reed, Columbus, OH (US)

(72) Inventor: Camas Elaine Reed, Columbus, OH (US)

(21) Appl. No.: 13/594,026

(22) Filed: Aug. 24, 2012

(51) Int. Cl. H01R 13/60

(52) U.S. Cl. 439/569

(57) ABSTRACT

A dual coupler stay includes a base, a cleat configured for receipt within an aperture defined by a vehicle, and a post. The base is positioned longitudinally between the cleat and the post and each of the cleat and the post is integral with the base and extends longitudinally away from the base. The dual coupler stay also includes a first flange and a second flange laterally spaced from the first flange. Each of the first flange and the second flange is integral with and extends away from the post, and is configured to support a respective electrical coupler of a vehicle. The dual coupler stay also includes a spacer that is integral with the post and extends away from the post. The spacer is positioned laterally between the first flange and the second flange.

### TECHNICAL FIELD

This application relates generally to devices used to support electrical couplers of vehicle wiring harnesses, and more particularly to a dual coupler stay.

### BACKGROUND

Known devices that are used to support electrical couplers of vehicle wiring harnesses include those that support two electrical couplers.

### SUMMARY

According to one embodiment, a dual coupler stay includes a base and a cleat configured for receipt within an aperture defined by a vehicle. The cleat is integral with the base and extends longitudinally away from the base. The dual coupler stay also includes a post integral with the base and extending longitudinally away from the base. The base is positioned longitudinally between the cleat and the post. The dual coupler stay further includes a first flange and a second flange laterally spaced from the first flange. Each of the first flange and the second flange is integral with the post and extends away from the post. Each of the first flange and the second flange is configured to support a respective electrical coupler of a vehicle. The dual coupler stay also includes a spacer integral with the post and extending away from the post. The spacer includes a first side surface and a second side surface. The spacer is positioned laterally between the first flange and the second flange. The spacer is laterally spaced from each of the first flange and the second flange such that the first side surface of the spacer faces the first flange and the second side surface of the spacer faces the second flange.

According to another embodiment, a dual coupler stay includes a base that includes a contact member and a platform integral with the contact member. The platform includes a longitudinally-facing surface. The dual coupler stay also includes a cleat configured for receipt within an aperture defined by a vehicle. The cleat is integral with, and extends longitudinally away from, the contact member of the base. The dual coupler stay also includes a post integral with the platform and extending longitudinally away from the longitudinally-facing surface of the platform. The base is positioned longitudinally between the cleat and the post. The dual coupler stay further includes a first flange, a second flange, and a spacer. The first flange includes an inner side surface and an outer side surface. The second flange is laterally spaced from the first flange and includes an inner side surface and an outer side surface. Each of the first flange and the second flange is integral with the post and extends away from the post. Each of the first flange and the second flange is configured to support a respective electrical coupler of a vehicle. The spacer is integral with the post and extends away from the post. The spacer is positioned laterally between the first flange and the second flange and is laterally spaced from each of the first flange and the second flange. At least a portion of the longitudinally-facing surface of the platform is positioned within a first plane. The first plane is perpendicular to a second plane that extends through the post and the spacer. Each of the inner side surface of the first flange and the inner side surface of the second flange is parallel with the second plane.

According to another embodiment, a dual coupler stay includes a base, a cleat, and a post. The cleat is configured for receipt within an aperture defined by a vehicle. The base is positioned longitudinally between the cleat and the post, and each of the cleat and the post is integral with the base and extends longitudinally away from the base. The dual coupler stay also includes a first flange and a second flange laterally spaced from the first flange. Each of the first flange and the second flange is integral with the post and extends away from the post. Each of the first flange and the second flange is configured to support a respective electrical coupler of a vehicle. The dual coupler stay further includes a spacer integral with the post and extending away from the post. The first flange and the second flange each comprise an inner side surface and an outer side surface. The inner side surface of the first flange is parallel to the inner side surface of the second flange. The spacer is equidistant laterally from the inner side surface of the first flange and the inner side surface of the second flange.

### BRIEF DESCRIPTION OF THE DRAWINGS

Various embodiments of a dual coupler stay will become better understood with regard to the following description, appended claims and accompanying drawings wherein:

FIG. 1 is a perspective view depicting a portion of an engine compartment of a vehicle that contains a dual coupler stay according to one embodiment, with the dual coupler stay supporting two electrical couplers of the vehicle;

FIG. 2 is a perspective view depicting the dual coupler stay shown partially in FIG. 1;

FIG. 3 is a side elevational view of the dual coupler stay of FIG. 2;

FIG. 4 is a top plan view of the dual coupler stay of FIG. 2;

FIG. 5 is a perspective view of the dual coupler stay of FIG. 2 and the two electrical couplers depicted in FIG. 1 that are supported by the dual coupler stay; and

FIG. 6 is a perspective view of a Prior Art single coupler stay.

### DETAILED DESCRIPTION

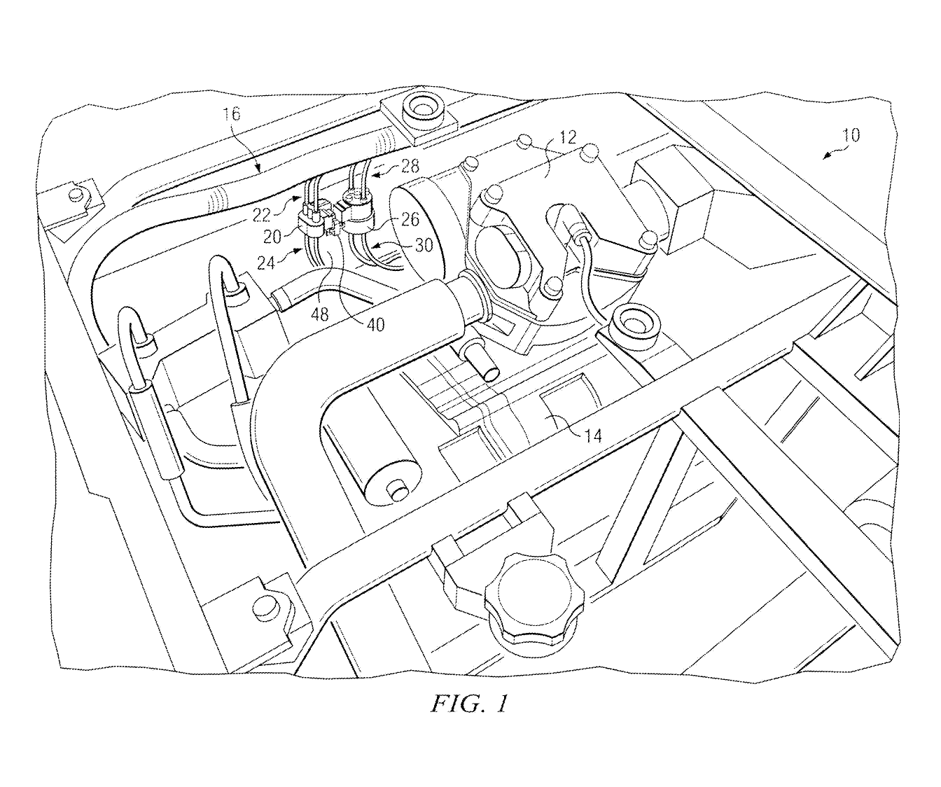

Referring to the drawings, wherein like reference numbers indicate the same or corresponding elements throughout the views, FIG. 1 depicts an engine compartment 10 of a vehicle, which can house, or contain, various components of the vehicle. For example, at least a portion of an engine 12 and at least a portion of a transmission 14, which can be coupled with the engine 12, can be positioned within the engine compartment 10. At least a portion of an electrical wiring harness 16 can also be positioned within engine compartment 10, with the electrical wiring harness 16 being in electrical communication with one or more electrical components of the vehicle.

A plurality of electrical couplers can also be positioned within compartment 10. For example, an electrical coupler 20 can be positioned within engine compartment 10 and can couple wires 22 of wiring harness 16 with respective ones of wires 24 that can be in electrical communication with an electrical component (not shown) of the vehicle. Similarly, an electrical coupler 26 can be positioned within engine compartment 10 and can couple wires 28 of wiring harness 16 with respective ones of wires 30 that can be in electrical communication with another electrical component (not shown) of the vehicle.

A dual coupler stay 40 according to one embodiment can also be positioned within the engine compartment 10 and can be used to support each of the electrical couplers 20 and 26, as shown in FIG. 1. The dual coupler stay 40 can be attached to a frame 48 of the vehicle. In other applications, dual coupler stays (e.g., 40) can be attached to any other suitable portion of the respective vehicle, for example, a body panel or fender of the vehicle, or a support bracket, etc. The dual coupler stay 40 is shown to be positioned within an engine compartment 10 of a multi-use vehicle (“MUV”). However, dual coupler stays (e.g., 40) can be used with any of a variety of other types of vehicles that can include, but are not limited to, all terrain vehicles, motorcycles, personal watercrafts, utility vehicles, trucks, vans, or automobiles, etc.

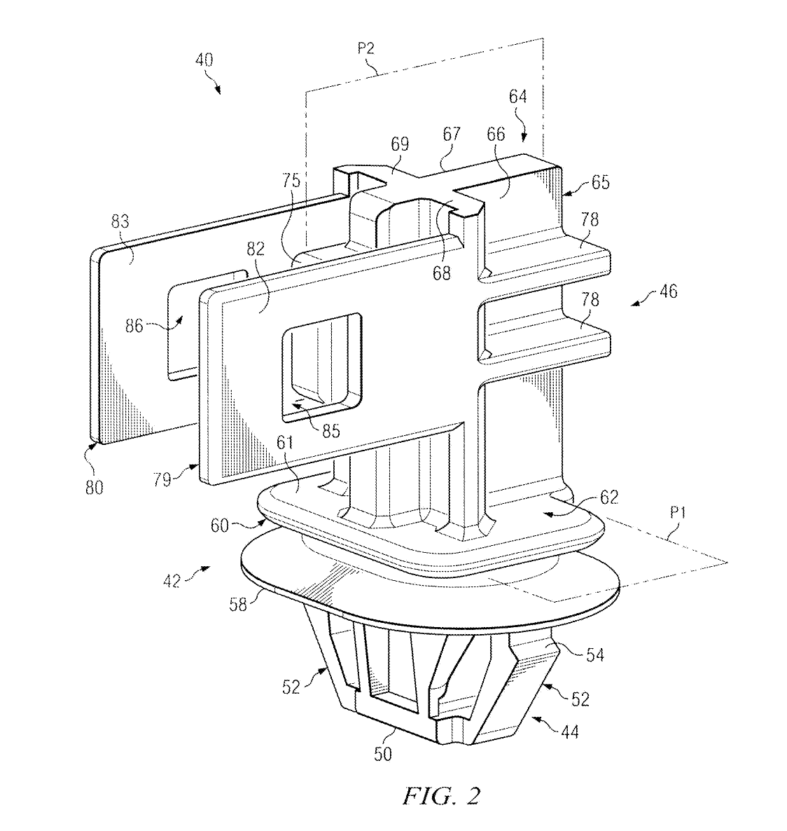

Referring to FIGS. 2-4, the dual coupler stay 40 can include a base 42, a cleat 44, and a post 46. In one embodiment, the base 42, cleat 44, and post 46 can be integrally formed from any suitable plastic material as a unitary structure. The cleat 44 can be configured for receipt within an aperture defined by the vehicle. For example, cleat 44 can be received within an aperture (not shown) defined by the frame 48 of the vehicle which is shown partially in FIG. 1. The cleat 44 can be integral with the base and can extend longitudinally away from the base as shown in FIGS. 2 and 3. In one embodiment, the cleat 44 can be generally wedged-shaped. The cleat 44 can include a generally central portion 50 and a pair of side portions 52, which each can be integral with the generally central portion 50. Each of the side portions 52 can be inclined with respect to the generally central portion 50 of cleat 44 to create the generally wedge shape of cleat 44. The cleat 44 can define one or more apertures, as shown in FIG. 2, for weight and cost reduction purposes. The side portions 52 of cleat 44 can be sized and configured such that the cleat 44 can be “snapped” into the respective aperture defined by the vehicle. Each of the side portions 52 of cleat 44 can include a surface 54, which can be positioned proximate the base 42 and can be angled, for example as shown in FIG. 2. The surfaces 54 of cleat 44 can cooperate with the base 42 to secure the dual coupler stay 40 to the particular portion of the vehicle to which they are attached, for example by clamping or clipping the dual coupler stay 40 to the frame 48 of the vehicle. The minimum distance between the surfaces 54 of cleat 44 and base 42 can be sized such that the surfaces 54 and the base 42 are compressed against opposite sides of the portion of the vehicle, for example frame 48, to which the dual coupler stay 40 is attached.

The base 42 can include a contact member 58 and can include a platform 60, which can be integral with the contact member 58. As shown in FIG. 3, the contact member 58 can have a generally frusto-conical shape. The cleat 44 can be integral with the contact member 58 and can extend longitudinally away from the contact member 58. The platform 60 can include a longitudinally-facing surface 61. At least a portion of the longitudinally-facing surface 61 of platform 60 can be positioned within a first plane P1 (FIGS. 2 and 3).

The post 46 can include a first end 62 integral with base 42 and a second end 64 spaced from the base 42, as shown in FIG. 2. The post 46 can be integral with the platform 60 of base 42 and can extend longitudinally away from the longitudinally-facing surface 61 of platform 60, as shown in FIG. 2. The post 46 can include a beam 65 having a first side surface 66 and a second side surface 67. Post 46 can also include a first cross-member 68 and a second cross-member 69. The first cross-member 68 can extend laterally away from the first side surface 66 of beam 65 and the second cross-member 69 can extend laterally away from the second side surface 67 of beam 65. Each of the beam 65, the first cross-member 68 and the second cross-member 69 can extend longitudinally away from the longitudinally-facing surface 61 of platform 60.

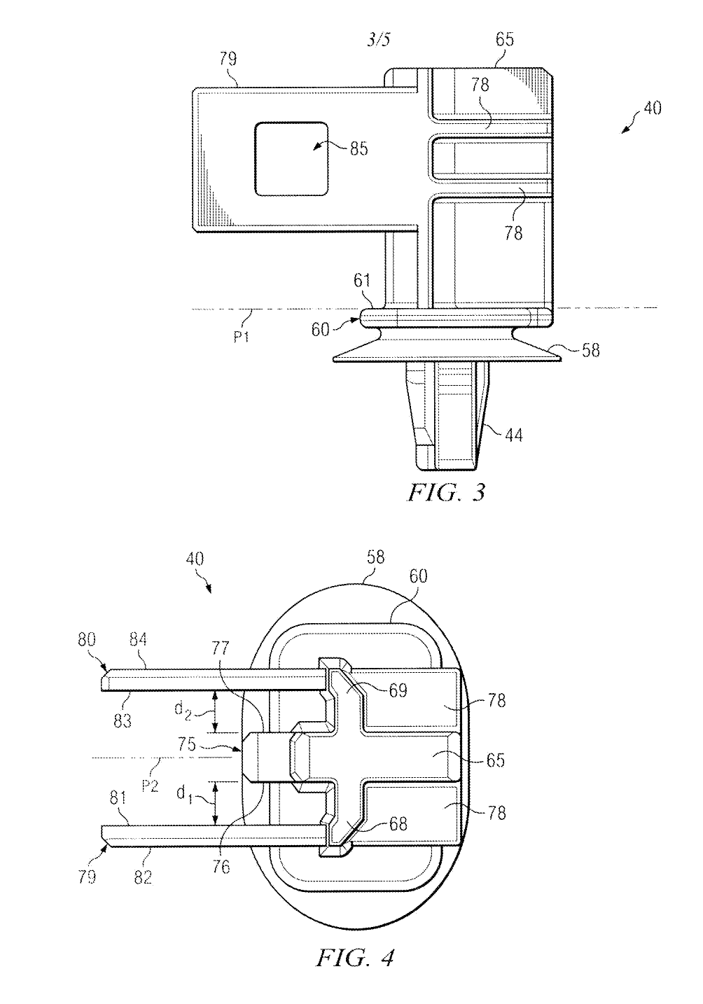

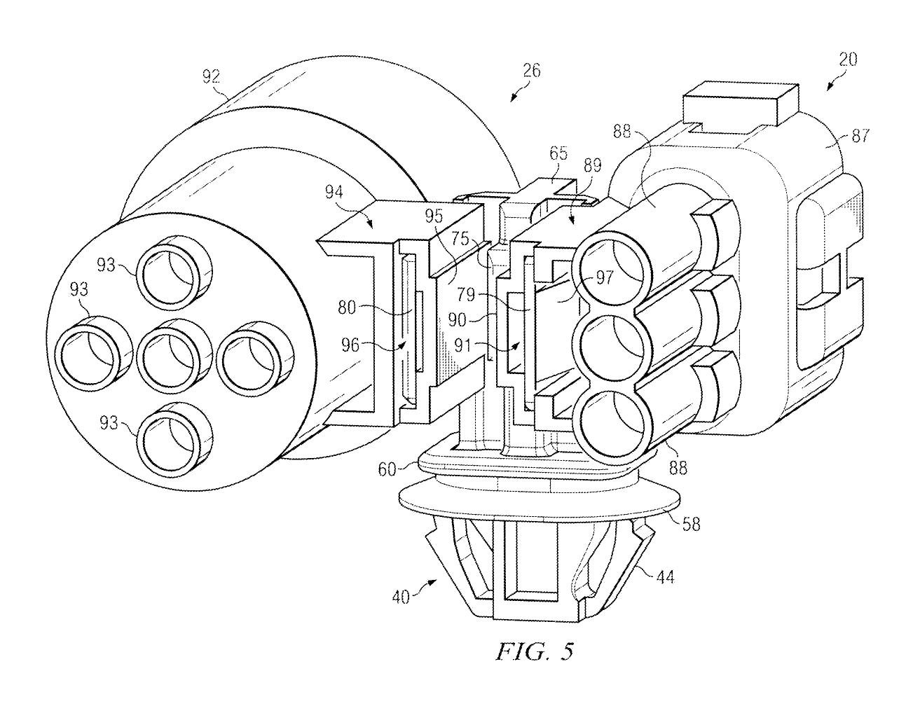

The dual coupler stay 40 can also include a spacer 75 that can be integral with the beam 65 and that can extend away from the beam 65. The spacer 75 can be longitudinally spaced from the base 42, and can be positioned longitudinally between the first end 62 and the second end 64 of the post 46, as shown in FIG. 2. The spacer 75 can include a first side surface 76 and a second side surface 77, as shown in FIG. 4.

The dual coupler stay 40 can also include a plurality of reinforcement ribs 78, which can be integral with the post 46 and which can enhance the structural rigidity of the dual coupler stay 40. The dual coupler stay 40 can include two of the reinforcement ribs 78 integral with the first side surface 66 of beam 65 and with the first cross-member 68, as shown in FIG. 2. The dual coupler stay 40 can also include two of the reinforcement ribs 78 (one shown in FIG. 4) that can be integral with the second side surface 67 of beam 65 and with the second cross-member 69. In other embodiments, dual coupler stays can be provided with one, or more than two, reinforcement ribs integral with a respective side of a beam of the dual coupler stay and with a respective cross-member of the dual coupler stay. In other embodiments, dual coupler stays can be provided that do not include any reinforcement ribs.

The dual coupler stay 40 can also include a first flange 79 and a second flange 80 that can be laterally spaced from the first flange 79. Each of the first flange 79 and the second flange 80 can be integral with, and can extend away from, the post 46. As shown in FIG. 2, the first flange 79 can be integral with, and can extend away from, the first cross-member 68 and the second flange 80 can be integral with, and can extend away from, the second cross-member 69 of post 46. Referring to FIGS. 2 and 4, the first flange 79 can include an inner side surface 81 and an outer side surface 82, and the second flange 80 can include an inner side surface 83 and an outer side surface 84.

The spacer 75 can be positioned laterally between the first flange 79 and the second flange 80, with the spacer 75 being laterally spaced from each of the first flange 79 and the second flange 80 such that the first side surface 76 of the spacer 75 faces the inner side surface 81 of the first flange 79 and the second side surface 77 of the spacer 75 faces the inner side surface 83 of the second flange 80. In one embodiment, the spacer 75 can be equidistant laterally from the first flange 79 and the second flange 80, such that a distance “d₁” between the first side surface 76 of spacer 75 and the inner side surface 81 of the first flange 79 can be the same as a distance “d₂” between the second side surface 77 of spacer 75 and the inner side surface 83 of the second flange 80, as shown in FIG. 4.

In one embodiment, the inner side surface 81 of the first flange 79 can be parallel with the inner side surface 83 of the second flange 80. A second plane P2 can extend through the beam 65 of the post 46 and through the spacer 75, and can be transverse to the first plane P1. In one embodiment, the second plane P2 can bisect the beam 65 and the spacer 75 laterally, and can be perpendicular to the first plane P1. Each of the inner side surface 81 of the first flange 79, the inner side surface 83 of the second flange 80, the first side surface 76 of spacer 75, and the second side surface 77 of spacer 75, can be parallel with the second plane P2.

Each of the first flange 79 and the second flange 80 can be configured to support a respective electrical coupler of a vehicle. The first flange 79 can define a first aperture 85 that can be configured to receive a portion of an electrical coupler of a vehicle. As shown in FIG. 2, the first aperture 85 can extend through each of the inner side surface 81 and the outer side surface 82 of the first flange 79. The second flange 80 can define a second aperture 86 that can be configured to receive a portion of an electrical coupler of a vehicle. As shown in FIG. 2, the second aperture 86 can extend through each of the inner side surface 83 and the outer side surface 84 of the second flange 80. As shown in FIGS. 2 and 3 with respect to the first aperture 85, each of the first aperture 85 and the second aperture 86 can have a generally square shape. However, each of the first aperture 85 and the second aperture 86 can have any one of a variety of other suitable shapes that can be configured to receive a portion of a respective electrical coupler of a vehicle.

The dual coupler stay 40 can support two electrical couplers of a vehicle. For example, as shown in FIGS. 1 and 5, the dual coupler stay 40 can support the electrical coupler 20 and the electrical coupler 26. The electrical coupler 20 can include a housing 87 and a plurality of receptacles 88 that can be configured to receive electrical wires, such as wires 22 shown in FIG. 1 (not shown in FIG. 5). The electrical coupler 20 can also include a mount structure 89 that can be integral with the housing 87. The mount structure 89 can include an inner surface 90, which can be planar. The mount structure 89 can define an aperture 91. The electrical coupler 26 can include a housing 92 and a plurality of receptacles 93 that can be configured to receive electrical wires, for example wires 28 shown in FIG. 1 (not shown in FIG. 5). The electrical coupler 26 can also include a mount structure 94 that can include an inner surface 95, which can be planar. The mount structure 94 can define an aperture 96.

The electrical coupler 20 can be secured to the dual coupler stay 40 by inserting the first flange 79 of the dual coupler stay 40 into the aperture 91 defined by the electrical coupler 20. During this process, a protrusion 97 of the electrical coupler 20 can snap into the first aperture 85 defined by the first flange 79 of the dual coupler stay 40, to facilitate securing the electrical coupler 20 to the dual coupler stay 40. Similarly, the electrical coupler 26 can be secured to the dual coupler stay 40 by inserting the second flange 80 of the dual coupler stay 40 into the aperture 96 defined by the electrical coupler 26. During this process, a protrusion (not shown) of the electrical coupler 26 can snap into the second aperture 86 defined by the second flange 80 of the dual coupler stay 40 to facilitate securing the electrical coupler 26 to the dual coupler stay 40. In one embodiment, when the electrical couplers 20 and 26 are secured to the dual coupler stay 40, the inner surface 90 of the mount structure 89 of the electrical coupler 20 can be in contacting engagement with the first side surface 76 of the spacer 75 of the dual coupler stay 40, and the inner surface 95 of the mount structure 94 of the electrical coupler 26 can be in contacting engagement with the second side surface 77 of the spacer 75 of the dual coupler stay 40, which can facilitate securely attaching the electrical couplers 20 and 26 to the dual coupler stay 40.

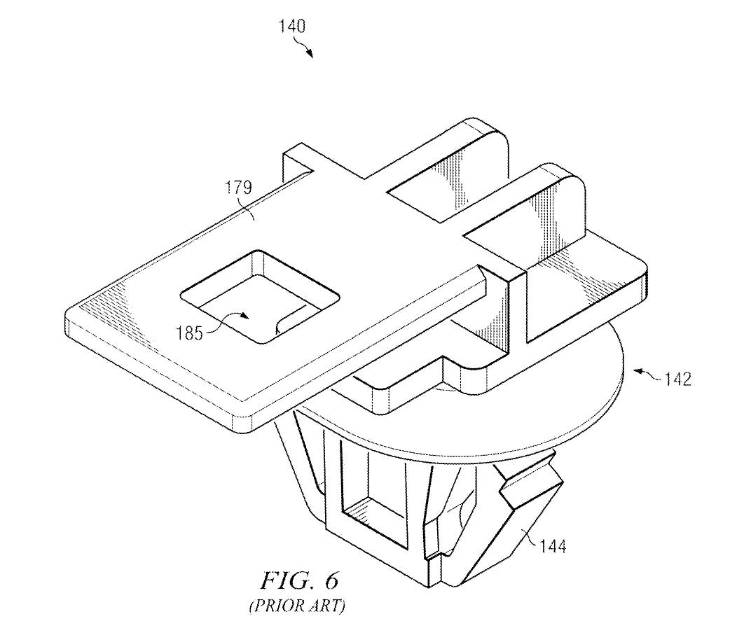

A Prior Art single coupler stay 140 is depicted in FIG. 6. The single coupler stay 140 includes a cleat 144 and a base 142 that is integral with the cleat 144. The cleat 144 is generally wedge-shaped. The single coupler stay 140 also includes a flange 179, which defines an aperture 185. The flange 179 is configured to support an electrical coupler of a vehicle, and the aperture 185 is configured to receive a portion of an electrical coupler of a vehicle.

Use of dual coupler stays such as the dual coupler stay 40 can result in various advantages. As more electrical technology is added to a vehicle, the quantity of required electrical couplers can increase, and in some vehicles the available space to locate such electrical couplers can be somewhat limited. Use of dual coupler stays (e.g., 40) can increase layout flexibility with respect to the routing of electrical wiring harnesses and the associated electrical couplers. Accordingly, the use of dual coupler stays can enhance the efficient use of the available space to locate electrical couplers. Use of dual coupler stays can also result in cost and weight reductions. For example, fewer required stays can result in fewer holes, or apertures, that must be created in mating vehicle components, for example the vehicle frame, to receive the stays to support the electrical couplers. Also, wiring design can be optimized to reduce cost and weight as a result of smaller quantities of wire, tubing, tape, etc. Assembly time can be reduced, as a result of inserting fewer stays into the respective mating apertures formed in the vehicle component, which can also result in a cost reduction. The incorporation of a spacer (e.g., 75) on dual coupler stays (e.g., 40) can enhance the structural rigidity of the assembly of the dual coupler stay (e.g., 40) and two electrical couplers (e.g., 20, 26) supported by the dual coupler stay due to the contacting engagement between a surface (e.g., 90, 95) of the mount structure (e.g., 89, 94) of each electrical coupler (e.g., 20, 26) and a respective side surface (e.g., 76, 77) of the spacer (e.g., 75) of the dual coupler stay (e.g., 40). Supporting two electrical couplers (e.g., 20, 26) on the dual coupler stay (e.g., 40) can also enhance the balance of the assembly of the dual coupler stay (e.g., 40) and the two electrical couplers (e.g., 20, 26).

While various embodiments of a dual coupler stay have been described in considerable detail, it is not intended to restrict or in any way limit the scope of the appended claims to such detail. Additional modifications will be readily apparent to those skilled in the art.

What is claimed is:

1. A dual coupler stay comprising:
a base;
a cleat configured for receipt within an aperture defined by a vehicle, the cleat being integral with the base and extending longitudinally away from the base;
a post integral with the base and extending longitudinally away from the base, the base being positioned longitudinally between the cleat and the post;
a first flange and a second flange laterally spaced from the first flange, each of the first flange and the second flange being integral with the post and extending away from the post, each of the first flange and the second flange being configured to support a respective electrical coupler of a vehicle;
a spacer integral with the post and extending away from the post, the spacer comprising a first side surface and a second side surface; wherein
the spacer is positioned laterally between the first flange and the second flange, the spacer being laterally spaced from each of the first flange and the second flange such that the first side surface of the spacer faces the first flange and the second side surface of the spacer faces the second flange.

2. The dual coupler stay of claim 1, wherein:
the first flange comprises an inner side surface and an outer side surface;
the second flange comprises an inner side surface and an outer side surface;
the first side surface of the spacer faces the inner side surface of the first flange; and
the second side surface of the spacer faces the inner side surface of the second flange.

3. The dual coupler stay of claim 2, wherein:
the inner side surface of the first flange is parallel to the inner side surface of the second flange.

4. The dual coupler stay of claim 3, wherein:
the first flange defines a first aperture and the second flange defines a second aperture, each of the first aperture and the second aperture being configured to receive a portion of a respective electrical coupler of a vehicle.

5. The dual coupler stay of claim 3, wherein:
the post comprises a beam, the beam comprising a first side surface and a second side surface;
the post further comprises a first cross-member and a second cross-member, the first cross-member extending laterally away from the first side surface of the beam, the second cross-member extending laterally away from the second side surface of the beam; and
the first flange is integral with, and extends away from, the first cross-member and the second flange is integral with, and extends away from, the second cross-member.

6. The dual coupler stay of claim 5, wherein:
the base comprises a contact member and a platform integral with the contact member; and
the post extends longitudinally away from the platform and the cleat extends longitudinally away from the contact member.

7. The dual coupler stay of claim 5, further comprising:
a plurality of reinforcement ribs, each of the reinforcement ribs being integral with the post.

8. The dual coupler stay of claim 1, wherein:
the base, the cleat, the post, the first flange, the second flange and the spacer are integrally formed from a plastic material as a unitary structure.

9. The dual coupler stay of claim 3, wherein:
the base comprises a platform, the platform comprising a longitudinally-facing surface; and
the post comprises a beam, the beam extending longitudinally away from the longitudinally-facing surface of the platform.

10. The dual coupler stay of claim 9, wherein:
at least a portion of the longitudinally-facing surface of the platform is positioned within a first plane;
the first plane is perpendicular to a second plane that extends through the beam and the spacer; and
each of the inner side surface of the first flange and the inner side surface of the second flange is parallel with the second plane.

11. The dual coupler stay of claim 10, wherein:
each of the first side surface of the spacer and the second side surface of the spacer is parallel with the second plane.

12. The dual coupler stay of claim 4, wherein:
the first aperture extends through each of the inner side surface and the outer side surface of the first flange; and
the second aperture extends through each of the inner side surface and the outer side surface of the second flange.

13. A dual coupler stay comprising:
a base comprising a contact member and a platform integral with the contact member, the platform comprising a longitudinally-facing surface;
a cleat configured for receipt within an aperture defined by a vehicle, the cleat being integral with, and extending longitudinally away from, the contact member of the base;
a post integral with the platform and extending longitudinally away from the longitudinally-facing surface of the platform, the base being positioned longitudinally between the cleat and the post;
a first flange comprising an inner side surface and an outer side surface;
a second flange laterally spaced from the first flange, the second flange comprising an inner side surface and an outer side surface, each of the first flange and the second flange being integral with the post and extending away from the post, each of the first flange and the second flange being configured to support a respective electrical coupler of a vehicle;
a spacer integral with the post and extending away from the post; wherein
the spacer is positioned laterally between the first flange and the second flange and is laterally spaced from each of the first flange and the second flange;
at least a portion of the longitudinally-facing surface of the platform is positioned within a first plane;
the first plane is perpendicular to a second plane that extends through the post and the spacer; and
each of the inner side surface of the first flange and the inner side surface of the second flange is parallel with the second plane.

14. The dual coupler stay of claim 13, wherein:
the spacer comprises a first side surface and a second side surface, each of the first side surface and the second side surface being parallel with the second plane.

15. The dual coupler stay of claim 14, wherein:
the post comprises a beam; and
the second plane extends through the beam.

16. The dual coupler stay of claim 15, wherein:
the beam comprises a first side surface and a second side surface;
the post further comprises a first cross-member and a second cross-member, the first cross-member extending laterally away from the first side surface of the beam, the second cross-member extending laterally away from the second side surface of the beam; and
the first flange is integral with, and extends away from, the first cross-member and the second flange is integral with, and extends away from, the second cross-member.

17. A dual coupler stay comprising:
a base:
a cleat configured for receipt within an aperture defined by a vehicle;
a post, the base being positioned longitudinally between the cleat and the post, each of the cleat and the post being integral with the base and extending longitudinally away from the base;
a first flange and a second flange laterally spaced from the first flange, each of the first flange and the second flange being integral with the post and extending away from the post, each of the first flange and the second flange being configured to support a respective electrical coupler of a vehicle;
a spacer integral with the post and extending away from the post; wherein
the first flange and the second flange each comprise an inner side surface and an outer side surface;
the inner side surface of the first flange is parallel to the inner side surface of the second flange; and
the spacer is equidistant laterally from the inner side surface of the first flange and the inner side surface of the second flange.

18. The dual coupler stay of claim 17, wherein:
the first flange defines a first aperture that extends through each of the inner side surface and the outer side surface of the first flange;
the second flange defines a second aperture that extends through each of the inner side surface and the outer side surface of the second flange; and
each of the first aperture and the second aperture is configured to receive a portion of a respective electrical coupler of a vehicle.

19. The dual coupler stay of claim 18, wherein:
the base comprises a contact member and a platform integral with the contact member, the platform comprising a longitudinally-facing surface;
the cleat extends longitudinally away from the contact member; and
the longitudinally-facing surface of the platform is planar and the post extends longitudinally away from the longitudinally-facing surface.

20. The dual coupler stay of claim 17, wherein:
the base, the cleat, the post, the first flange, the second flange, and the spacer are integrally formed from a plastic material as a unitary structure.
